(19) United States
(12) Patent Application Publication
(10) Pub. No.: US 2007/0115693 A1
(43) Pub. Date: May 24, 2007

(54) Backlight module having light guide plate with positioning member for positioning optical films

(75) Inventor: Wei Shu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/601,914

(22) Filed: Nov. 20, 2006

(30) Foreign Application Priority Data
Nov. 18, 2005 (TW) 94140628

(51) Int. Cl. F21V 7/04

(52) U.S. Cl. 362/633; 362/607

(57) ABSTRACT

A backlight module (2) includes a light guide plate (24) having a light incident surface (241) and a light output surface (242) adjacent to the incident surface; a light source (25) disposed adjacent to the light incident surface; and plural optical films (22, 23). The light guide plate further includes plural positioning members (245) at a periphery of the light output surface, and the positioning members are configured for positioning the optical films on or above the light output surface. Therefore the backlight module having the optical films can be mechanically stable and operate properly.

### FIELD OF THE INVENTION

The present invention relates to backlight modules typically used for liquid crystal display (LCD) devices, and especially to a backlight module having a light guide plate with a positioning member for positioning one or more optical films thereon.

### BACKGROUND

Liquid crystal displays are commonly used as display devices for compact electronic apparatuses, because they not only provide good quality images with little power but also are very thin. The liquid crystal in a liquid crystal display does not emit any light itself. The liquid crystal has to be lighted by a light source so as to clearly and sharply display text and images. Thus, a backlight module is generally needed for a liquid crystal display.

FIG. 6 is a schematic, exploded, isometric view of a conventional backlight module. The backlight module 1 includes a top frame 11, a prism film 12, a diffusion film 13, a light guide plate 14, a cold cathode fluorescent lamp (CCFL) 15, a lamp cover 16, a reflective film 17, and a bottom frame 18.

The prism film 12 and the diffusion film 13 are optical films. The prism film 12 includes two opposite protrusions 121. The diffusion film 13 includes two opposite protrusions 131, corresponding in position to the protrusions 121 of the prism film 12. The light guide plate 14 includes an elongate light incident surface 141. The CCFL 15 is elongate, and is disposed adjacent the light incident surface 141. The lamp cover 16 is elongate, and covers the CCFL 15. The top frame 11 engages with the bottom frame 18 to form a space. The space contains the reflective film 17, the light guide plate 14, the diffusion film 13, and the prism film 12, in that order from bottom to top:

Also referring to FIGS. 7 and 8, the protrusions 121 and 131 of the prism film 12 and diffusion film 13 are contained in corresponding cutout portions (not labeled) of the bottom frame 18. Thereby, the optical films 12 and 13 are retained on the light guide plate 14 in the bottom frame 18. However, the protrusions 121 and 131 are not necessarily snugly received in the cutout portions. The optical films 12 and 13 are liable to shift in the bottom frame 18. The backlight module 1 may become loose and unstable, and this may impair the performance of the backlight module 1.

Accordingly, what is needed is a backlight module that can overcome the above-described deficiencies.

### SUMMARY

An exemplary backlight module includes a light guide plate having a light incident surface and a light output surface adjacent to the incident surface; a light source disposed adjacent to the light incident surface; and at least one optical film. The light output surface of the light guide plate includes positioning member for positioning the at least one optical film.

Other advantages and novel features will become more apparent from the following detailed description of preferred embodiments when taken in conjunction with the accompanying drawings. In the drawings, all the views are schematic.

### BRIEF DESCRIPTION OF THE DRAWINGS

FIG. 1 is an exploded, isometric view of a backlight module according to a first embodiment of the present invention.

FIG. 2 is an assembled view of a light guide plate, a CCFL, and a reflective film of the backlight module of FIG. 1.

FIG. 3 is an assembled view of the light guide plate, the CCFL, the reflective film, and a bottom frame of the backlight module of FIG. 1.

FIG. 4 is an assembled view of the backlight module of FIG. 1.

FIG. 5 is an isometric view of a light guide plate of a backlight module according to a second embodiment of the present invention.

FIG. 6 is an exploded, isometric view of a conventional backlight module.

FIG. 7 is an assembled view of the backlight module of FIG. 6.

FIG. 8 is an enlarged view of a circled portion VIII of FIG. 7.

### DETAILED DESCRIPTION OF PREFERRED EMBODIMENTS

Reference will now be made to the drawings to describe the preferred embodiments in detail.

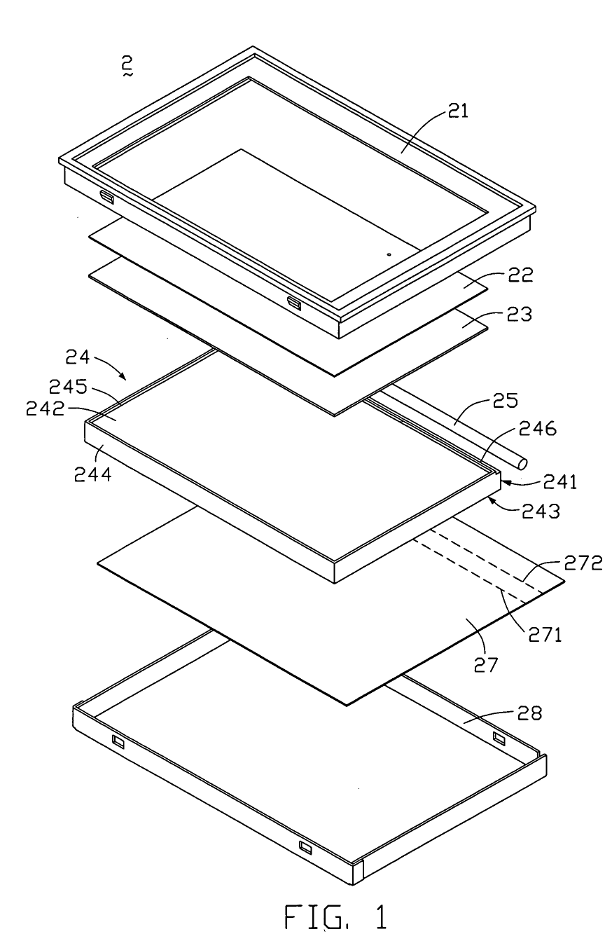

FIG. 1 is an exploded, isometric view of a backlight module 2 according to a first embodiment of the present invention. The backlight module 2 includes a plastic frame 21, a prism film 22, a diffusion film 23, a light guide plate 24, a light source 25, a reflective film 27, and an metal frame 28 arranged generally in that order from top to bottom. The prism film 22 and the diffusion film 23 are optical films. The light source 25 may be a cold cathode fluorescent lamp (CCFL). The metal frame 28 can be made of aluminum, metal, or any other suitable metal or alloy.

The light guide plate 24 includes a light incident surface 241, a light output surface 242 generally adjacent to the light incident surface 241, a bottom surface 243 opposite to the light output surface 242, and three side surfaces 244 adjacent to the bottom surface 243. A plurality of flanges 245 is formed at edge portions of the light output surface 242. In the illustrated embodiment, there are four flanges 245, which are joined end-to-end to cooperatively form a four-sided closed structure. A horizontal step portion 246 is formed between the light incident surface 241 and the flange 245 adjacent to the light incident surface 241. An outmost vertical surface of each of the other three flanges 245 forms a part of the corresponding adjacent side surface 244. The flanges 245 are integrally formed with the light guide plate 24, and cooperate with the light output surface 242 to form a shallow space (not labeled) therebetween. The reflective film 27 includes a first crease 271, and a second crease 272 parallel to the first crease 271.

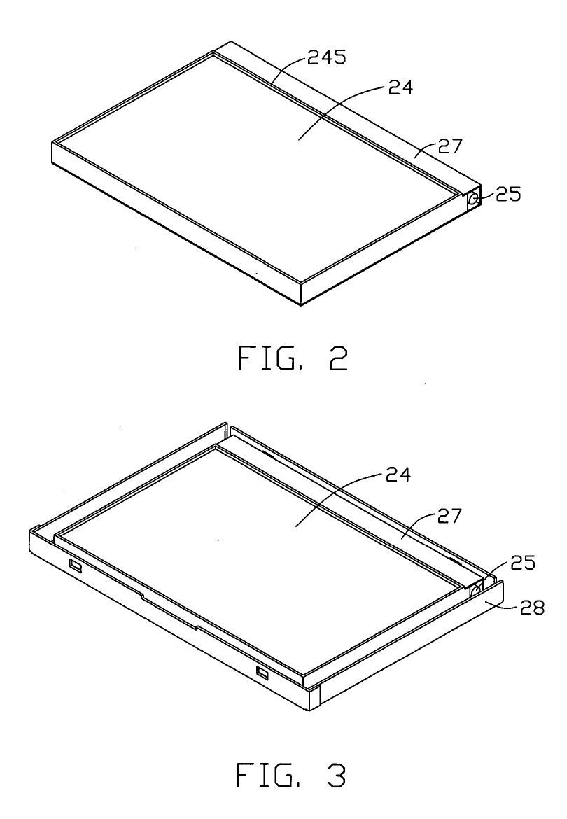

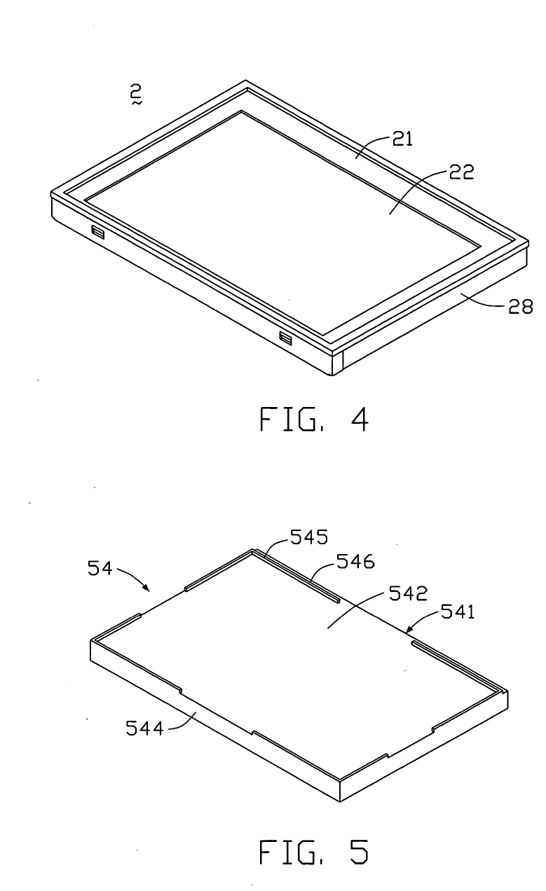

Also referring to FIGS. 2-4, when the backlight module 2 is assembled, the light source 25 is positioned adjacent to the light incident surface 241 of the light guide plate 24. The reflective film 27 is attached to the bottom surface 243 of the light guide plate 24, and is perpendicularly folded along the first and second creases 271 and 272 to form a cover that covers three sides of the light source 25. A distal edge of the reflective film 27 is fixed to the step portion 246. The reflective film 27, light guide plate 24, and light source 25 are received in the metal frame 28. The diffusion film 23 and the prism film 22 are received in the shallow space formed by the flanges 245 and the light output surface 242. Finally, the plastic frame 21 is engaged with the metal frame 28 to thereby fix the above-described components therein. Thus, assembly of the backlight module 2 is completed.

The flanges 246 can firmly fix the diffusion film 23 and the prism film 22 on the light output surface 242 of the light guide plate 24. Therefore the backlight module 2 having the optical films 22, 23 can be mechanically stable and operate properly. Furthermore, the distal edge of the reflective film 27 is fixed to the step 246 formed between the light incident surface 241 and the adjacent flange 246. Therefore there is no need for a light source cover, which lowers the cost and the weight of the backlight module 2.

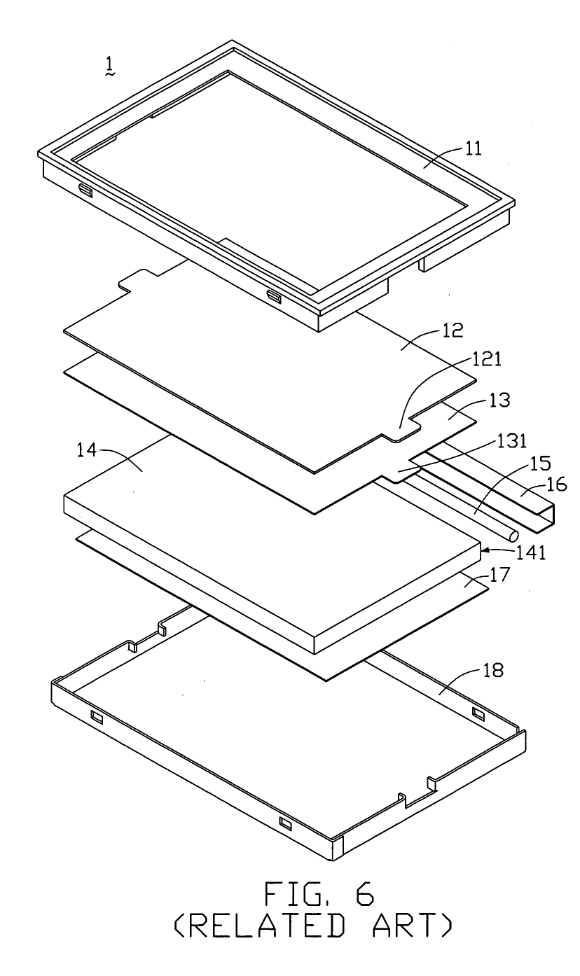

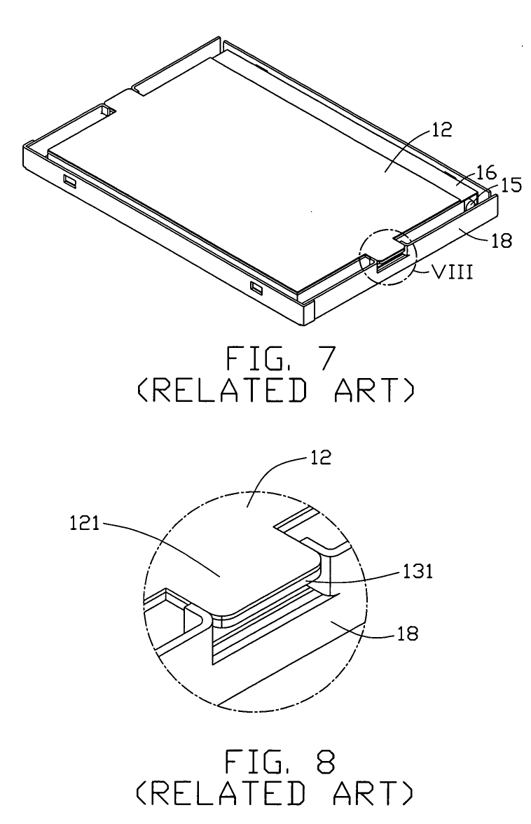

FIG. 5 is an isometric view of a light guide plate of a backlight module according to a second embodiment of the present invention. The light guide plate 54 has a structure similar to that of the light guide plate 24. However, the light guide plate 54 includes four L-shaped flanges 545 disposed at four comers (not labeled) of a light output surface 542 thereof. A horizontal step portion 546 is formed between a light incident surface 541 of the light guide plate 54 and two of the flanges 545 adjacent to the light incident surface 541. An outmost vertical surface of each of portions of the flanges 545 adjacent to three side surfaces 544 of the light guide plate 54 forms a part of the corresponding adjacent side surface 544.

In alternative embodiments, only one optical film may be employed, or three or more optical films may be employed.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module, comprising:
a light guide plate comprising a light incident surface and a light output surface adjacent to the incident surface;
a light source disposed adjacent to the light incident surface; and
at least one optical film;
wherein the light guide plate further comprises at least one positioning member at a periphery of the light output surface, and the at least one positioning member is configured for positioning the at least one optical film on or above the light output surface.

2. The backlight module as claimed in claim 1, wherein the at least one positioning member comprises at least one flange disposed at at least one edge of the light output surface of the light guide plate.

3. The backlight module as claimed in claim 2, wherein a step portion is formed between the light incident surface and one flange of the at least one flange that is generally adjacent to the light incident surface.

4. The backlight module as claimed in claim 3, wherein the light guide plate further comprises three side surfaces generally adjacent to the light output surface.

5. The backlight module as claimed in claim 4, wherein the at least one flange is three flanges located at the side surfaces respectively, and an outmost surface of each of the flanges forms a part of the corresponding adjacent side surface.

6. The backlight module as claimed in claim 1, wherein the at least one positioning member comprises four L-shaped flanges disposed at four comers of the light output surface of the light guide plate.

7. The backlight module as claimed in claim 6, wherein a step portion is formed between the light incident surface and portions of two of the flanges that are generally adjacent to the light incident surface.

8. The backlight module as claimed in claim 1, wherein the at least one positioning member is an integral part of the light guide plate.

9. The backlight module as claimed in claim 3, further comprising a reflective film.

10. The backlight module as claimed in claim 9, wherein the reflective film comprises a first crease and a second crease.

11. The backlight module as claimed in claim 10, wherein the reflective film is folded along the first and second creases to form a cover that covers three sides of the light source.

12. The backlight module as claimed in claim 11, wherein a distal edge of the reflective film is attached to the step portion.

13. The backlight module as claimed in claim 1, wherein the at least one optical film is selected from the group consisting of a diffusion film and a prism film.

14. A backlight module, comprising:
a light guide plate comprising a light incident surface and a light output surface adjacent to the incident surface;
a light source disposed adjacent to the light incident surface; and
at least one optical film; wherein
the light guide plate further comprises unitarily at least one positioning member horizontally confining the light output surface, and the at least one positioning member is configured for positioning the at least one optical film on or above the light output surface.

15. The backlight module as claimed in claim 14, wherein the at least one positioning member cooperates with the light output surface to form a space receiving the at least one optical film therein.
